(19) United States
(12) Patent Application Publication
(10) Pub. No.: US 2024/0314277 A1
(43) Pub. Date: Sep. 19, 2024

(54) AUTOMATIC PROJECTION CORRECTION

(71) Applicant: INTEL CORPORATION, Santa Clara, CA (US)

(72) Inventors: Bo PENG, Beijing (CN); Bin WANG, Beijing (CN)

(21) Appl. No.: 18/568,780

(22) PCT Filed: Dec. 10, 2021
(86) PCT No.: PCT/CN2021/136939

§ 371 Date: Dec. 8, 2023

(51) Int. Cl. H04N 9/31

(52) U.S. Cl. CPC H04N 9/3185; H04N 9/3194

(57) ABSTRACT

This disclosure describes systems, methods, and devices related to automatic projection correction. A device may generate a first image having a first resolution. The device may project the first image onto a surface resulting in a first projected image on a first projection area. The device may receive input data from a depth camera device, wherein the input data is associated with the first projected image on the first projected area. The device may perform automatic projection correction based on the input data. The device may generate a second image to be projected based on the automatic projection correction. The device may project the second image onto a second projection area.

### TECHNICAL FIELD

This disclosure generally relates to systems and methods for wireless communications and, more particularly, to automatic projection correction.

### BACKGROUND

A projector is an output device that projects images onto a surface, such as a screen or wall. It may be used as an alternative to a monitor or television when showing video or images to users. Images projected on a surface are arranged in a manner so that the projection images from the projectors are overlapped with each other in overlapped areas, so that a single and high-resolution image can be projected on the surface.

### BRIEF DESCRIPTION OF THE DRAWINGS

FIG. 1 illustrates example environment of an automatic projection correction system, in accordance with one or more example embodiments of the present disclosure.

FIGS. 2A-2E depict illustrative schematic diagrams for automatic projection correction, in accordance with one or more example embodiments of the present disclosure.

FIGS. 3A-3B depict illustrative schematic diagrams for automatic projection correction, in accordance with one or more example embodiments of the present disclosure.

FIGS. 4A-4B depict illustrative schematic diagrams for automatic projection correction, in accordance with one or more example embodiments of the present disclosure.

FIGS. 5A-5B depict illustrative schematic diagrams for automatic projection correction, in accordance with one or more example embodiments of the present disclosure.

FIG. 6 illustrates a flow diagram of a process for an illustrative automatic projection correction system, in accordance with one or more example embodiments of the present disclosure.

FIG. 7 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

A projector accepts a video or image input, processes it with the assistance of its inbuilt optical projection system consisting of a lens and optical source, and projects the enhanced output on the projection screen. When the projector is projected non-perpendicularly onto the projection area, the projected image will look trapezoidal, rather than a rectangle or square, this is referred to as the keystone effect. Keystone correction, also called keystoning, is a function that attempts to make the skew projecting image rectangle.

A current solution is to use an ordinary camera, after collecting the red-green-blue (RGB) data, locate the four corners of the projection area, and then implement corrections.

In this way, the pixel positions of the four corners can be obtained, but the actual projection position and the shape information of the projection area cannot be obtained.

Merely using RGB data is problematic in some specific situations, for example, the projection surface is not a large plane, but a raised blackboard. For another example, the edge of the projection area is not flat, or there are many items in the projection area, etc. Therefore, there is a need to implement a solution that performs Keystone correction based on collected data.

Example embodiments of the present disclosure relate to systems, methods, and devices for automatic projection correction.

In one or more embodiments, an automatic projection correction system may facilitate a RGB-D camera-assist automatic keystoning method, which uses both RGB and depth information of the projected area, generates a projection area, and performs warp-perspective to each frame.

In one or more embodiments, an automatic projection correction system may use a depth image to determine the plane distribution of the projection area. The automatic projection correction system may combine the RGB image to determine the corrected projection area. The one-to-one mapping relationship between the original image and the projection position is determined by calculating the homograph matrix mapping, and then the original image is corrected and projected to the corresponding area.

In one or more embodiments, an automatic projection correction system may combine depth images to determine the projection area. In a complex environment, depth information can be used to determine the area available for projection and perform projection. For example, automatically select the largest plane in the projection area for projection, and automatically avoid protruding items on the wall surface, etc.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

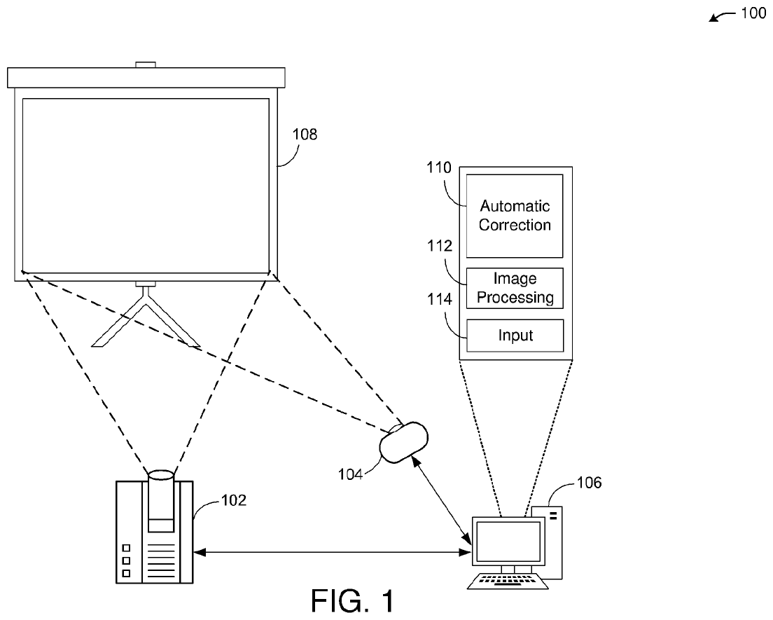

FIG. 1 depicts an illustrative schematic diagram for an automatic projection correction system 100, in accordance with one or more example embodiments of the present disclosure.

Referring to FIG. 1, there is shown a projector 102 projecting images onto a projection area 108. The projector 102 may be placed in a non-perpendicular fashion to the projection area 108. Therefore, the keystone effect may result. The automatic projection correction system 100 may include a computer system 106 that may be connected to the projector 102. The computer system 106 may be internal or external to the projector 102. The computer system 106 may also be connected to a depth camera 104. The depth camera 104 may be used to translate to Cartesian coordinates in 3D space. The computer system 106 may execute algorithms and perform functions that may implement the functionality of the automatic projection correction system 100, in accordance with one or more example embodiments of the present disclosure. For example, the computer system 106 may receive input data 114 from the projector 102 and/for the depth camera 104. The computer system 106 may also perform image processing 112 and automatic correction 110.

In one or more embodiments, an automatic projection correction system 100 may facilitate collecting input data 114 associated with a projected image in order to perform automatic correction 110. The automatic correction 110 may calculate a correspondence between the original image and the projected image in order to perform the image correction. Knowing the original image and the desired resolution of the original image to be projected by projector 102, allows the automatic projection correction system 100 to convert the original image to a new image to be projected on a new area based on utilizing the depth camera 104 and the computer system 106.

In one or more embodiments, an automatic projection correction system 100 may facilitate a RGB-D camera-assist automatic keystoning method. A RGB-D image is simply a combination of a RGB image and its corresponding depth image. A depth image is an image channel in which each pixel relates to a distance between the image plane and the corresponding object in the RGB image. The RGB-D camera-assist automatic keystoning method may use both RGB and depth information of the projected area in order to generate a new projection area based on performing warp-perspective to each frame. In other words, the automatic projection correction system 100 may use the depth image to determine the plane distribution of the projection area and combine the RGB image to determine the corrected projection area. The one-to-one mapping relationship between the original image and the projection position is determined by calculating the homograph matrix mapping, and then the original image is corrected and projected onto the corresponding area.

This solution combines depth images to determine a new and improved projection area. In a complex environment, depth information can be used to determine the area available for projection and perform the projection based on that determination. For example, an automatic projection correction system may automatically select the largest plane in the projection area for projection that automatically avoids protruding items on the wall surface, etc.

It is understood that the above descriptions are for purposes of illustration and are not meant to be limiting.

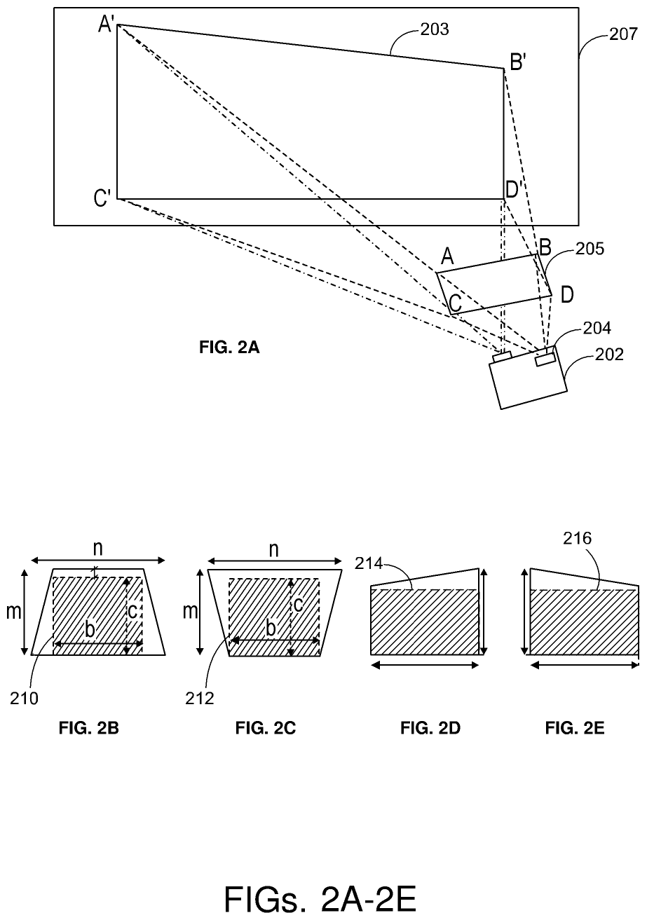

FIGS. 2A-2E depict illustrative schematic diagrams for automatic projection correction, in accordance with one or more example embodiments of the present disclosure.

Referring to FIG. 2A, there is shown projector 202 that may be projecting an image 205 onto surface 207. The projector 202 may utilize an internal projection system to process video or image input and then generate image 205 that is shown to be projected on the surface 207 as a projected image 203. The image 205 may have a certain image resolution associated with it.

When a projector is placed in a non-perpendicular fashion with the projection area, the projected image will look trapezoidal, rather than a rectangle or square, this is called the keystone effect. Referring to FIG. 2A, the projector 202 may be placed in a non-perpendicular manner to surface 207. That placement of the projector 202 may result in a skewed projection of the original image 205 resulting in the projected image 203. However, if the projector 202 was perpendicular to the surface 207, the projected image 203 may be more rectangular. Here, the projected image 203 is shown to have four corners A′, B′, C′, and D′. These points form a trapezoid shape due to the placement of the projector 202 relative to the surface 207.

In one or more embodiments, an automatic projection correction system may facilitate utilizing software to deform the original graphics (e.g., image 205) to change the projected image (e.g., projected image 203) from a trapezoid to a normal rectangle. In this process, a camera 204 may be used to collect the projected image 203 and calculate a correspondence between the original image 205 and the projected image 203. The camera 204 may be a depth camera. A depth camera has pixels that have a different numerical value associated with them, that number being the distance from the camera, or “depth.” Some depth cameras have both an RGB and a depth system, which can give pixels with all four values, or RGBD.

By utilizing the camera 204 with the projector 202, RGB data may be used to identify the four corners (e.g., four corners A′, B′, C′, and D′) of the projected image 203. These four corners' locations (e.g., coordinates) may be used by the camera 204 to translate to cartesian coordinates in 3D space.

FIGS. 2B-2E show various possible trapezoidal shapes that may result from a skewed projected image on a surface. For example, looking at FIG. 2B, there is shown a trapezoid having a width value n and a height value m. An automatic projection correction system may generate an enhanced projected image 210 that maintains the image resolution as was desired when image 205 was generated before projection. The enhanced projected image 210 may be the largest possible rectangle that may fit in the trapezoid shape without changing the resolution of the original image 205. The enhanced projected image 210 may then be determined to have a height c and a width b that results in the same resolution as the original image 205. Similarly looking at FIGS. 2C, 2D, and 2E, different trapezoidal shapes may be enhanced using the automatic projection correction system by generating enhanced projected images (e.g., enhanced projected images 212, 214, and 216) that meet the image resolution of the original image 205.

The automatic projection correction system may utilize input received from camera 204. The camera 204 may collect data associated with the projected image 203. For example, the camera 204 may determine the coordinates of A′, B′, C′, and D′. From there, an automatic projection correction system may calculate the length of all four sides of the projected image 203 (e.g., A′B′, A′C′, C′D′, B′D′). These lengths may be used to identify the shape of distortion based on the projector 202 placement relative to surface 207. Knowing the projected image 203 and the original image 205, an automatic projection correction system may utilize a mammography matrix that maps between these two images in order to generate an enhanced image to be projected on surface 207. The enhanced image may be any of the enhanced projected images 210, 212, 214, or 216.

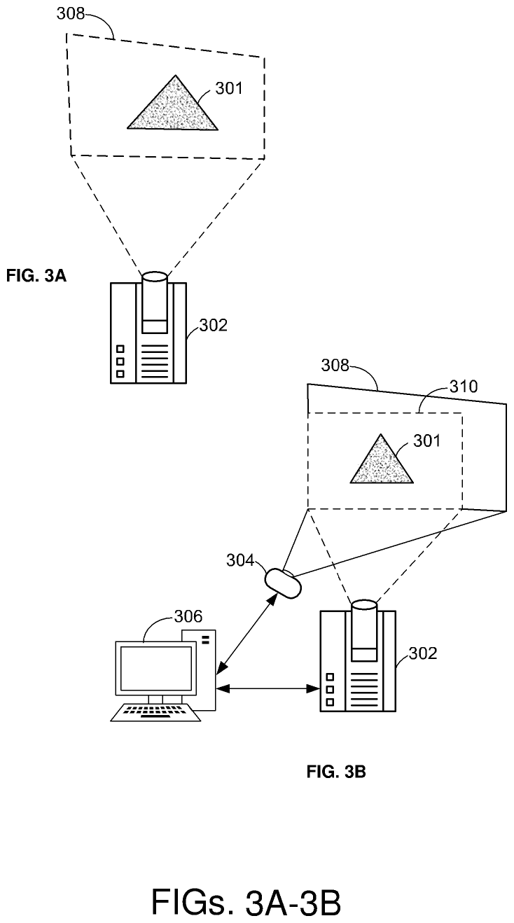

FIGS. 3A-3B depict illustrative schematic diagrams for automatic projection correction, in accordance with one or more example embodiments of the present disclosure.

Referring to FIG. 3A, there is shown a projector 302 projecting on a surface a projected image 308 showing object 301. The projected image 308 has a trapezoidal shape instead of a rectangle shape as expected. Referring to FIG. 3B, there is shown an automatic projection correction system that may enhance the projected image 308 into a rectangle or projected image 310 showing objects 301.

In one or more embodiments, an automatic projection correction system may utilize depth camera 304 in conjunction with computer system 306 and the projector 302 in order to enhance the output of the projector 302 resulting in the projected image 310. The automatic projection correction system may determine the coordinates of the projected image 308 using the camera 304. Then, the position coordinates of the corrected distortion output corners can be calculated. Using the pixel location of source image corners and corrected distortion output corners, it may be possible to calculate a 3×3 homograph matrix, which correlates the original image with the projected image 308. Then, the computer system 306 may perform warp perspective transformation to every input frame in order to correct every output projected frame. This result is shown in projected image 310.

It is understood that the above descriptions are for purposes of illustration and are not meant to be limiting.

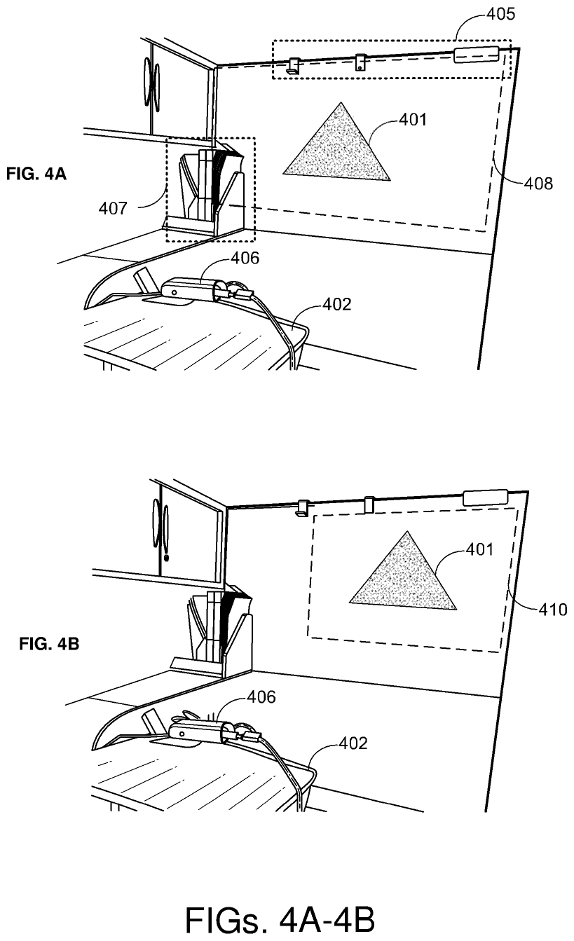

FIGS. 4A-4B depict illustrative schematic diagrams for automatic projection correction, in accordance with one or more example embodiments of the present disclosure.

Referring to FIG. 4A, there is shown a projector 402 that may be projecting object 401 on a projected area 408. The projector 402 may also be equipped with a camera 406 that may be a depth camera. The camera 406 may obtain information associated with the surface shape of the projection area 408. The camera 406 may assist the projector 402 to perform as expected by projecting a rectangular projected area and avoiding objects in a complex environment. In the example of FIG. 4A objects 405 and 406 may be placed in front of the projector 402 causing the projected image 408 to overlap on top of these objects. An automatic projection correction system may facilitate utilizing the camera 406 in order to generate depth information to detect objects obstructing the projected area 408. In this example, objects 407 and 405 are shown to be obstructing the projected area 408.

Referring to FIG. 4B, an automatic projection correction system may generate a new projected area 410 that considers the depth information associated with objects 405 and 407 while maintaining the resolution of the original image of object 401. Therefore, the new projected area 410 avoids objects 405 and 407.

It is understood that the above descriptions are for purposes of illustration and are not meant to be limiting.

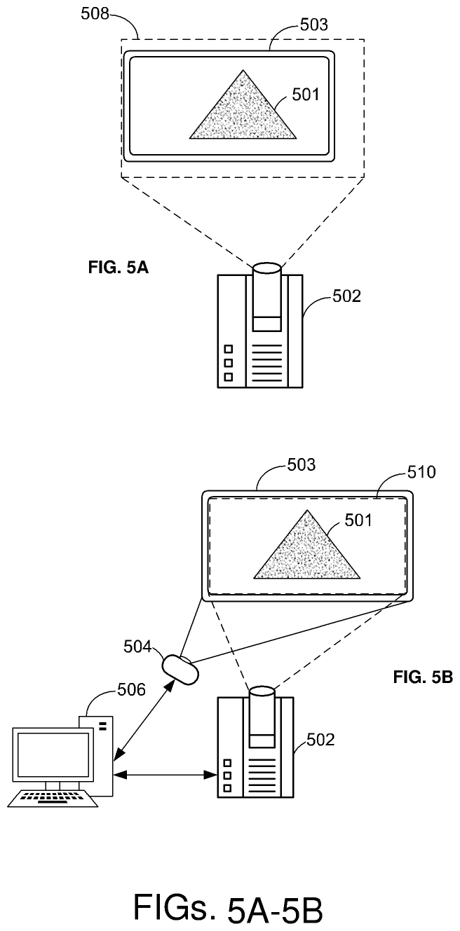

FIGS. 5A-5B depict illustrative schematic diagrams for automatic projection correction, in accordance with one or more example embodiments of the present disclosure.

Referring to FIG. 5A, there is shown a projector 502 projecting an image 508 showing an object 501. The image 508 may cover a raised blackboard 503. It may be intended for the image 508 to fit within the border of the raised blackboard 503.

Referring to FIG. 5B, a depth camera 504 may be utilized in order to adjust and enhance the image 508 in order to generate a new projected image 510 that fits within the border of the raised blackboard 503.

In one or more embodiments, the depth camera 504 may determine the planar position of the protrusion (e.g., raised edge of the blackboard 503). The depth camera 504 may generate data that may be used by a computer system 506 to perform correction to the image frame to fit in the corresponding area of the blackboard 503 by avoiding the raised edge of the blackboard 503.

In general, the use of the camera (e.g., RGB camera) of the projector 502 to correct the projector is limited. However, the use of the depth camera 504 may solve these limitations. In the case of projecting to a complex wall, the depth information can be used to make a judgment about the surface and select the corresponding corrected projection area for projection. It is understood that the above descriptions are for purposes of illustration and are not meant to be limiting.

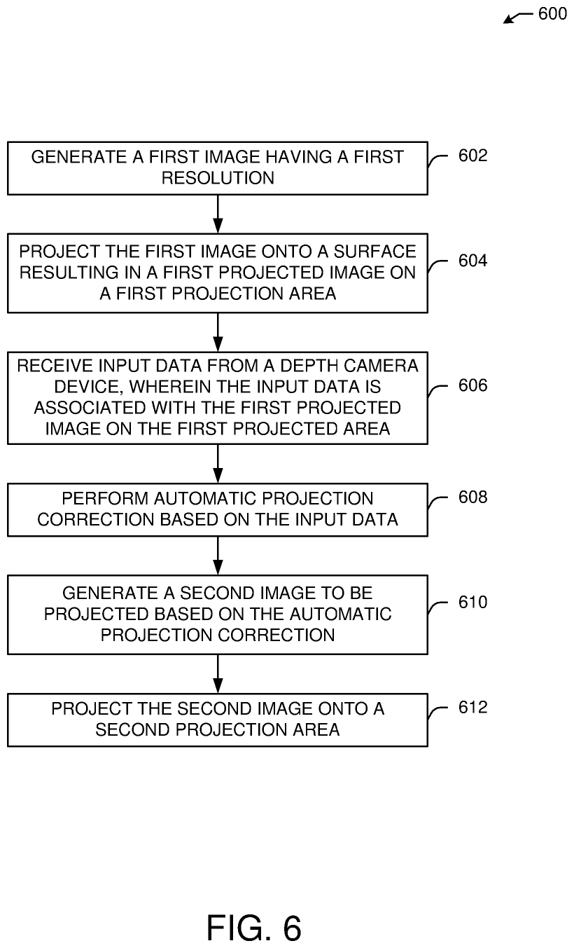

FIG. 6 illustrates a flow diagram of a process 600 for an automatic projection correction system, in accordance with one or more example embodiments of the present disclosure.

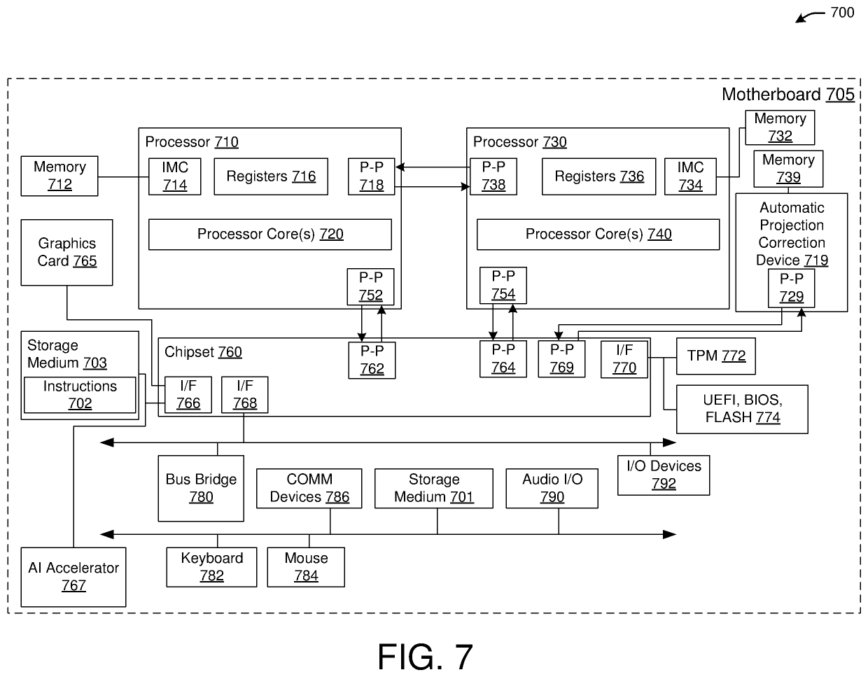

At block 602, a device (e.g., the automatic projection correction device of FIG. 1 and/or the automatic projection correction device 719 of FIG. 7) may generate a first image having a first resolution.

At block 604, the device may project the first image onto a surface resulting in a first projected image on a first projection area. The first projected area is non-perpendicular to an axis of a lens of a projector. The surface may comprise a raised edge.

At block 606, the device may receive input data from a depth camera device, wherein the input data is associated with the first projected image on the first projected area.

At block 608, the device may perform automatic projection correction based on the input data. Performing the automatic projection correction may comprise applying a homograph matrix between a relationship of the first image and the first projected image. The second image has the same resolution as the first image. The device may detect one or more objects inside the first projected area, wherein the one or more objects interfere with the first projected image.

At block 610, the device may generate a second image to be projected based on the automatic projection correction. The device may generate the largest rectangle associated with the first projected area while keeping the first resolution based on the input data from the depth camera device. The device may adjust the first projected area based on the input data from the depth camera device to avoid the one or more objects. The input data may comprise pixel positions of four corners of the first projected image, projection position, and shape information of the first projected image.

At block 612, the device may project the second image onto a second projection area.

It is understood that the above descriptions are for purposes of illustration and are not meant to be limiting.

FIG. 7 illustrates an embodiment of an exemplary system 700, in accordance with one or more example embodiments of the present disclosure.

In various embodiments, the system 700 may comprise or be implemented as part of an electronic device.

In some embodiments, the system 700 may be representative, for example, of a computer system such as computer system 106 FIG. 1.

The embodiments are not limited in this context. More generally, the system 700 is configured to implement all logic, systems, processes, logic flows, methods, equations, apparatuses, and functionality described herein and with reference to the figures.

The system 700 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other devices for processing, displaying, or transmitting information. Similar embodiments may comprise, e.g., entertainment devices such as a portable music player or a portable video player, a smartphone or other cellular phones, a telephone, a digital video camera, a digital still camera, an external storage device, or the like. Further embodiments implement larger-scale server configurations. In other embodiments, the system 700 may have a single processor with one core or more than one processor. Note that the term “processor” refers to a processor with a single core or a processor package with multiple processor cores.

In at least one embodiment, the computing system 700 is representative for example, of a computer system such as computer system 106 FIG. 1. More generally, the computing system 700 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 700. For example, a component can be but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 700 comprises a motherboard 705 for mounting platform components. The motherboard 705 is a point-to-point (P-P) interconnect platform that includes a processor 710, a processor 730 coupled via a P-P interconnects/interfaces as an Ultra Path Interconnect (UPI), and an automatic projection correction device 719. In other embodiments, the system 700 may be of another bus architecture, such as a multi-drop bus. Furthermore, each of processors 710 and 730 may be processor packages with multiple processor cores. As an example, processors 710 and 730 are shown to include processor core(s) 720 and 740, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 710 and the chipset 760. Some platforms may include additional components and some platforms may only include sockets to mount the processors and/or the chipset.

The processors 710 and 730 can be any of various commercially available processors, including without limitation an Intel® Celeron®, Core®, Core (2) Duo®, Itanium®, Pentium®, Xeon®, and XScale® processors; AMD® Athlon®, Duron®, and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 710, and 730.

The processor 710 includes an integrated memory controller (IMC) 714 and P-P interconnects/interfaces 718 and 752. Similarly, the processor 730 includes an IMC 734 and P-P interconnects/interfaces 738 and 754. The IMC's 714 and 734 couple the processors 710 and 730, respectively, to respective memories, a memory 712, and a memory 732. The memories 712 and 732 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 712 and 732 locally attach to the respective processors 710 and 730.

In addition to the processors 710 and 730, the system 700 may include an automatic projection correction device 719. The automatic projection correction device 719 may be connected to chipset 760 by means of P-P interconnects/interfaces 729 and 769. The automatic projection correction device 719 may also be connected to a memory 739. In some embodiments, the automatic projection correction device 719 may be connected to at least one of the processors 710 and 730. In other embodiments, the memories 712, 732, and 739 may couple with the processor 710 and 730, and the automatic projection correction device 719 via a bus and shared memory hub.

System 700 includes chipset 760 coupled to processors 710 and 730. Furthermore, chipset 760 can be coupled to storage medium 703, for example, via an interface (I/F) 766. The I/F 766 may be, for example, a Peripheral Component Interconnect-enhanced (PCI-e). The processors 710, 730, and the automatic projection correction device 719 may access the storage medium 703 through chipset 760. The automatic projection correction device 619 may implement one or more of the processes or operations described herein, (e.g., process 600 of FIG. 6).

Storage medium 703 may comprise any non-transitory computer-readable storage medium or machine-readable storage medium, such as an optical, magnetic, or semiconductor storage medium. In various embodiments, storage medium 703 may comprise an article of manufacture. In some embodiments, storage medium 703 may store computer-executable instructions, such as computer-executable instructions 702 to implement one or more of the processes or operations described herein, (e.g., process 600 of FIG. 6). The storage medium 703 may store computer-executable instructions for any equations depicted above. The storage medium 703 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 710 couples to a chipset 760 via P-P interconnects/interfaces 752 and 762 and the processor 730 couples to a chipset 760 via P-P interconnects/interfaces 754 and 764. Direct Media Interfaces (DMIs) may couple the P-P interconnects/interfaces 752 and 762 and the P-P interconnects/interfaces 754 and 764, respectively. The DMI may be a high-speed interconnect that facilitates, e.g., eight Giga Transfers per second (GT/s) such as DMI 3.0. In other embodiments, the processors 710 and 730 may interconnect via a bus.

The chipset 760 may comprise a controller hub such as a platform controller hub (PCH). The chipset 760 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 760 may comprise more than one controller hub such as a chipset with a memory controller hub, a graphics controller hub, and an input/output (I/O) controller hub.

In the present embodiment, the chipset 760 couples with a trusted platform module (TPM) 772 and the UEFI, BIOS, Flash component 774 via an interface (I/F) 770. The TPM 772 is a dedicated microcontroller designed to secure hardware by integrating cryptographic keys into devices. The UEFI, BIOS, Flash component 774 may provide pre-boot code.

Furthermore, chipset 760 includes the I/F 766 to couple chipset 760 with a high-performance graphics engine, graphics card 765. In other embodiments, the system 700 may include a flexible display interface (FDI) between the processors 710 and 730 and the chipset 760. The FDI interconnects a graphics processor core in a processor with the chipset 760.

Various I/O devices 792 couple to the bus 781, along with a bus bridge 780 that couples the bus 781 to a second bus 791 and an I/F 768 that connects the bus 781 with the chipset 760. In one embodiment, the second bus 791 may be a low pin count (LPC) bus. Various devices may couple to the second bus 791 including, for example, a keyboard 782, a mouse 784, communication devices 786, a storage medium 701, and an audio I/O 790.

The artificial intelligence (AI) accelerator 767 may be circuitry arranged to perform computations related to AI. The AI accelerator 767 may be connected to storage medium 701 and chipset 760. The AI accelerator 767 may deliver the processing power and energy efficiency needed to enable abundant data computing. The AI accelerator 767 is a class of specialized hardware accelerators or computer systems designed to accelerate artificial intelligence and machine learning applications, including artificial neural networks and machine vision. The AI accelerator 767 may be applicable to algorithms for robotics, internet of things, other data-intensive and/or sensor-driven tasks.

Many of the I/O devices 792, communication devices 786, and the storage medium 701 may reside on the motherboard 705 while the keyboard 782 and the mouse 784 may be add-on peripherals. In other embodiments, some or all the I/O devices 792, communication devices 786, and the storage medium 701 are add-on peripherals and do not reside on the motherboard 705.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The following examples pertain to further embodiments.

Example 1 may include a system that comprises at least one memory that stores computer-executable instructions; and at least one processor configured to access the at least one memory and execute the computer-executable instructions to: generate a first image having a first resolution; project the first image onto a surface resulting in a first projected image on a first projection area; receive input data from a depth camera device, wherein the input data may be associated with the first projected image on the first projected area; perform automatic projection correction based on the input data; generate a second image to be projected based on the automatic projection correction; and project the second image onto a second projection area.

Example 2 may include the system of example 1 and/or some other example herein, wherein performing the automatic projection correction comprises applying a homograph matrix between a relationship of the first image and the first projected image.

Example 3 may include the system of example 1 and/or some other example herein, wherein the second image has a same resolution as the first image.

Example 4 may include the system of example 1 and/or some other example herein, wherein the computer-executable instructions further comprise instructions to generate a largest rectangle associated with the first projected area while keeping the first resolution based on the input data from the depth camera device.

Example 5 may include the system of example 1 and/or some other example herein, wherein the computer-executable instructions further comprise instructions to detect one or more objects inside the first projected area, wherein the one or more objects interfere with the first projected image.

Example 6 may include the system of example 5 and/or some other example herein, wherein the computer-executable instructions further comprise instructions to adjust the first projected area based on the input data from the depth camera device to avoid the one or more objects.

Example 7 may include the system of example 1 and/or some other example herein, wherein the first projected area may be non-perpendicular to an axis of a lens of a projector.

Example 8 may include the system of example 1 and/or some other example herein, wherein the surface comprises a raised edge.

Example 9 may include the system of example 1 and/or some other example herein, wherein the input data comprises pixel positions of four corners of the first projected image, projection position, and shape information of the first projected image.

Example 10 may include a non-transitory computer-readable medium storing computer-executable instructions which when executed by one or more processors result in performing operations comprising: generating a first image having a first resolution; projecting the first image onto a surface resulting in a first projected image on a first projection area; receiving input data from a depth camera device, wherein the input data may be associated with the first projected image on the first projected area; performing automatic projection correction based on the input data; generating a second image to be projected based on the automatic projection correction; and projecting the second image onto a second projection area.

Example 11 may include the non-transitory computer-readable medium of example 10 and/or some other example herein, wherein performing the automatic projection correction comprises applying a homograph matrix between a relationship of the first image and the first projected image.

Example 12 may include the non-transitory computer-readable medium of example 10 and/or some other example herein, wherein the second image has a same resolution as the first image.

Example 13 may include the non-transitory computer-readable medium of example 10 and/or some other example herein, wherein the operations further comprise generating a largest rectangle associated with the first projected area while keeping the first resolution based on the input data from the depth camera device.

Example 14 may include the non-transitory computer-readable medium of example 10 and/or some other example herein, wherein the operations further comprise detecting one or more objects inside the first projected area, wherein the one or more objects interfere with the first projected image.

Example 15 may include the non-transitory computer-readable medium of example 14 and/or some other example herein, wherein the operations further comprise adjusting the first projected area based on the input data from the depth camera device to avoid the one or more objects.

Example 16 may include the non-transitory computer-readable medium of example 10 and/or some other example herein, wherein the first projected area may be non-perpendicular to an axis of a lens of a projector.

Example 17 may include the non-transitory computer-readable medium of example 10 and/or some other example herein, wherein the surface comprises a raised edge.

Example 18 may include the non-transitory computer-readable medium of example 10 and/or some other example herein, wherein the input data comprises pixel positions of four corners of the first projected image, projection position, and shape information of the first projected image.

Example 19 may include a method comprising: generating, by one or more processors, a first image having a first resolution; projecting the first image onto a surface resulting in a first projected image on a first projection area; receiving input data from a depth camera device, wherein the input data may be associated with the first projected image on the first projected area; performing automatic projection correction based on the input data; generating a second image to be projected based on the automatic projection correction; and projecting the second image onto a second projection area.

Example 20 may include the method of example 19 and/or some other example herein, wherein performing the automatic projection correction comprises applying a homograph matrix between a relationship of the first image and the first projected image.

Example 21 may include the method of example 19 and/or some other example herein, wherein the second image has a same resolution as the first image.

Example 22 may include the method of example 19 and/or some other example herein, further comprising generating a largest rectangle associated with the first projected area while keeping the first resolution based on the input data from the depth camera device.

Example 23 may include the method of example 19 and/or some other example herein, further comprising detecting one or more objects inside the first projected area, wherein the one or more objects interfere with the first projected image.

Example 24 may include the method of example 23 and/or some other example herein, further comprising adjusting the first projected area based on the input data from the depth camera device to avoid the one or more objects.

Example 25 may include the method of example 19 and/or some other example herein, wherein the first projected area may be non-perpendicular to an axis of a lens of a projector.

Example 26 may include the method of example 19 and/or some other example herein, wherein the surface comprises a raised edge.

Example 27 may include the method of example 19 and/or some other example herein, wherein the input data comprises pixel positions of four corners of the first projected image, projection position, and shape information of the first projected image.

Example 28 may include an apparatus comprising means for: generating a first image having a first resolution; projecting the first image onto a surface resulting in a first projected image on a first projection area; receiving input data from a depth camera device, wherein the input data may be associated with the first projected image on the first projected area; performing automatic projection correction based on the input data; generating a second image to be projected based on the automatic projection correction; and projecting the second image onto a second projection area.

Example 29 may include the apparatus of example 28 and/or some other example herein, wherein performing the automatic projection correction comprises applying a homograph matrix between a relationship of the first image and the first projected image.

Example 30 may include the apparatus of example 28 and/or some other example herein, wherein the second image has a same resolution as the first image.

Example 31 may include the apparatus of example 28 and/or some other example herein, further comprising generating a largest rectangle associated with the first projected area while keeping the first resolution based on the input data from the depth camera device.

Example 32 may include the apparatus of example 28 and/or some other example herein, further comprising detecting one or more objects inside the first projected area, wherein the one or more objects interfere with the first projected image.

Example 33 may include the apparatus of example 32 and/or some other example herein, further comprising adjusting the first projected area based on the input data from the depth camera device to avoid the one or more objects.

Example 34 may include the apparatus of example 28 and/or some other example herein, wherein the first projected area may be non-perpendicular to an axis of a lens of a projector.

Example 35 may include the apparatus of example 28 and/or some other example herein, wherein the surface comprises a raised edge.

Example 36 may include the apparatus of example 28 and/or some other example herein, wherein the input data comprises pixel positions of four corners of the first projected image, projection position, and shape information of the first projected image.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system, comprising:
at least one memory that stores computer-executable instructions; and
at least one processor configured to access the at least one memory and execute the computer-executable instructions to:
generate a first image having a first resolution;
project the first image onto a surface resulting in a first projected image on a first projection area;
receive input data from a depth camera device, wherein the input data is associated with the first projected image on the first projected area;
perform automatic projection correction based on the input data;
generate a second image to be projected based on the automatic projection correction; and
project the second image onto a second projection area.

2. The system of claim 1, wherein performing the automatic projection correction comprises applying a homograph matrix between a relationship of the first image and the first projected image.

3. The system of claim 1, wherein the second image has a same resolution as the first image.

4. The system of claim 1, wherein the computer-executable instructions further comprise instructions to generate a largest rectangle associated with the first projected area while keeping the first resolution based on the input data from the depth camera device.

5. The system of claim 1, wherein the computer-executable instructions further comprise instructions to detect one or more objects inside the first projected area, wherein the one or more objects interfere with the first projected image.

6. The system of claim 5, wherein the computer-executable instructions further comprise instructions to adjust the first projected area based on the input data from the depth camera device to avoid the one or more objects.

7. The system of claim 1, wherein the first projected area is non-perpendicular to an axis of a lens of a projector.

8. The system of claim 1, wherein the surface comprises a raised edge.

9. The system of claim 8, wherein the input data comprises pixel positions of four corners of the first projected image, projection position, and shape information of the first projected image.

10. A non-transitory computer-readable medium storing computer-executable instructions which when executed by one or more processors result in performing operations comprising:
generating a first image having a first resolution;
projecting the first image onto a surface resulting in a first projected image on a first projection area;
receiving input data from a depth camera device, wherein the input data is associated with the first projected image on the first projected area;
performing automatic projection correction based on the input data;
generating a second image to be projected based on the automatic projection correction; and
projecting the second image onto a second projection area.

11. The non-transitory computer-readable medium of claim 10, wherein performing the automatic projection correction comprises applying a homograph matrix between a relationship of the first image and the first projected image.

12. The non-transitory computer-readable medium of claim 10, wherein the second image has a same resolution as the first image.

13. The non-transitory computer-readable medium of claim 10, wherein the operations further comprise generating a largest rectangle associated with the first projected area while keeping the first resolution based on the input data from the depth camera device.

14. The non-transitory computer-readable medium of claim 10, wherein the operations further comprise detecting one or more objects inside the first projected area, wherein the one or more objects interfere with the first projected image.

15. The non-transitory computer-readable medium of claim 14, wherein the operations further comprise adjusting the first projected area based on the input data from the depth camera device to avoid the one or more objects.

16. The non-transitory computer-readable medium of claim 10, wherein the first projected area is non-perpendicular to an axis of a lens of a projector.

17. The non-transitory computer-readable medium of claim 10, wherein the surface comprises a raised edge.

18. The non-transitory computer-readable medium of claim 17, wherein the input data comprises pixel positions of four corners of the first projected image, projection position, and shape information of the first projected image.

19. A method comprising:
generating, by one or more processors, a first image having a first resolution;
projecting the first image onto a surface resulting in a first projected image on a first projection area;
receiving input data from a depth camera device, wherein the input data is associated with the first projected image on the first projected area;
performing automatic projection correction based on the input data;
generating a second image to be projected based on the automatic projection correction; and
projecting the second image onto a second projection area.

20. The method of claim 19, wherein performing the automatic projection correction comprises applying a homograph matrix between a relationship of the first image and the first projected image.

21-25. (canceled)
